(19) United States
(12) Patent Application Publication
(10) Pub. No.: US 2025/0026011 A1
(43) Pub. Date: Jan. 23, 2025

(54) MANIPULATOR

(71) Applicant: DAIFUKU CO., LTD., Osaka-shi, Osaka (JP)

(72) Inventors: Masahiro OOE, Hino-cho (JP); Shuei SENO, Hino-cho (JP)

(73) Assignee: DAIFUKU CO., LTD., Osaka-shi, Osaka (JP)

(21) Appl. No.: 18/715,214

(22) PCT Filed: Oct. 14, 2022
(86) PCT No.: PCT/JP2022/038330

§ 371 Date: May 31, 2024

(30) Foreign Application Priority Data
Dec. 3, 2021 (JP) 2021-196806

(51) Int. Cl. B25J 9/16; B23P 19/04; B25J 13/08; B25J 19/00; B62D 65/02; B62D 65/06

(52) U.S. Cl. CPC B25J 9/1633; B23P 19/04; B25J 9/1687; B25J 13/085; B25J 19/0091; B62D 65/024; B62D 65/06

(57) ABSTRACT

Provided is a manipulator in which reaction force caused in accordance with use of a tool part hardly reaches a force sensor. A manipulator includes: an arm (4); a force sensor (28) that is provided to the arm; a gripping part (34) that is provided to the arm via the force sensor and grips a workpiece; and a tool part (36) that is provided to the arm via a member different from the force sensor and carries out processing with respect to the workpiece which is gripped by the gripping part.

### TECHNICAL FIELD

The present disclosure relates to a manipulator in which a gripping part provided to an arm grips a workpiece.

### BACKGROUND ART

Patent Literature 1 discloses a support device for a component gripping device for gripping a door of an automobile in an automobile manufacturing line.

### CITATION LIST

### Patent Literature

### Patent Literature 1

Japanese Patent Application Publication Tokukai No. 2020-131355

### SUMMARY OF INVENTION

### Technical Problem

The support device for a component gripping device disclosed in Patent Literature 1 carries out position control of a door by a mechanical six-axis floating unit. A manipulator that grips a workpiece using a mechanical unit as described above causes an increase in the number of units and in the weight of units. In addition, the manipulator needs to keep adjusting force applied to the unit in accordance with change in posture of the unit. Therefore, content of control of the manipulator is complicated. Furthermore, for example, in a case where a removal device such as a nut runner for removing a workpiece from another member is attached to the unit, the unit receives reaction force which is caused in accordance with use of the removal device. Therefore, a withstand load of the unit is reduced, and the position control of the unit is difficult.

In this case, the following configuration may be considered: that is, a force sensor is provided to the door gripping member instead of the mechanical six-axis floating unit so that force or moment applied to the gripping member is detected by the force sensor, and thus causing the manipulator itself to carry out profile control. In this case, however, the force sensor receives reaction force which is caused in accordance with use of the removal device. Therefore, considering durability of the force sensor against moment, a withstand load of the manipulator is reduced.

### Solution to Problem

In order to attain the object, a manipulator in accordance with an aspect of the present disclosure includes: an arm; a force sensor that is provided to the arm; a gripping part that is provided to the arm via the force sensor and grips a first workpiece; and a tool part that is provided to the arm via a member different from the force sensor and carries out processing with respect to the first workpiece which is gripped by the gripping part.

### Advantageous Effects of Invention

According to an aspect of the present disclosure, a manipulator is provided in which a withstand load is improved while force or moment applied to a gripping part can be detected by a force sensor.

### BRIEF DESCRIPTION OF DRAWINGS

FIG. 1 is an enlarged schematic diagram illustrating the vicinity of a tip of an arm and the vicinity of a floating unit in a schematic perspective view of a manipulator in accordance with an embodiment of the present disclosure.

FIG. 2 is a schematic perspective view illustrating the manipulator in accordance with an embodiment of the present disclosure.

FIG. 3 is a perspective view for explaining a process of gripping a door and removing the door from a frame of a vehicle with use of the manipulator in accordance with an embodiment of the present disclosure.

FIG. 4 is a schematic side view illustrating a door which is gripped by the manipulator in accordance with an embodiment of the present disclosure.

FIG. 5 is a process cross-sectional view for describing profile control of a pin of a gripping part with respect to an opening of a door in accordance with an embodiment of the present disclosure.

### DESCRIPTION OF EMBODIMENTS

### Embodiment

### <Manipulator>

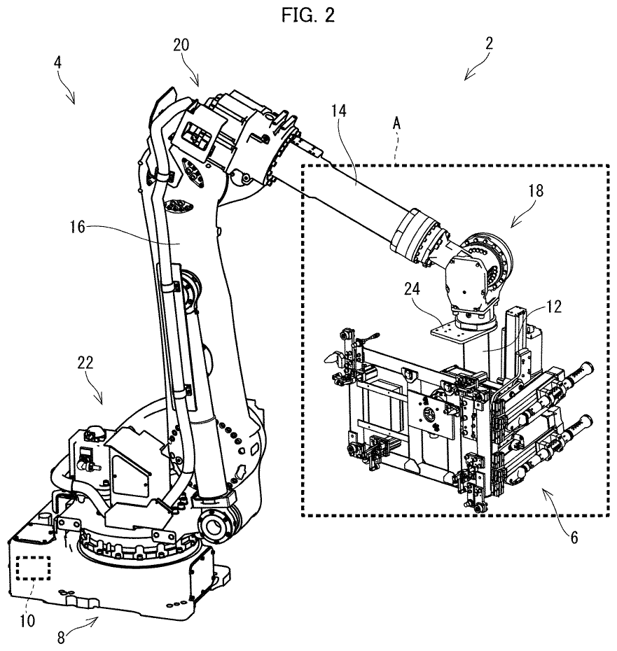

FIG. 2 is a schematic perspective view illustrating a manipulator in accordance with the present embodiment. As illustrated in FIG. 2, the manipulator 2 in accordance with the present embodiment includes an arm 4, a floating unit 6, a base part 8, and a control part 10.

The arm 4 is a flexible arm having a plurality of articulations. The arm 4 moves the floating unit 6 (later described in detail), which is provided at an end opposite to the base part 8, to various positions, and supports the floating unit 6 in various postures. As illustrated in FIG. 2, the arm 4 includes, for example, a floating arm 12, a first arm 14, and a second arm 16 in this order from the tip side to the base part 8 (i.e., the base). The arm 4 further includes a first articulation part 18, a second articulation part 20, and a third articulation part 22.

The first articulation part 18 joins the floating arm 12 to the first arm 14, the second articulation part 20 joins the first arm 14 to the second arm 16, and the third articulation part 22 joins the second arm 16 to the base part 8. In particular, the floating arm 12 may be provided to the first articulation part 18 via an arm joint part 24 illustrated in FIG. 2. The articulation parts of the arm 4 may be driven by a power unit (not illustrated). By changing relative angles of the respective arms that are joined to the articulation parts, a position and a posture of the floating unit 6 are changed.

The floating unit 6 is provided on the tip side of the arm 4, in particular, provided to the floating arm 12. Parts of the floating unit 6 will be described later in detail.

The control part 10 is, for example, located inside the base part 8 where the arm 4 is formed, and controls parts of the arm 4 and the floating unit 6. In the present embodiment, the control part 10 is not limited to this example, and may be provided outside the arm 4, the floating unit 6, and the base part 8. The control part 10 may control the parts of the arm 4 and the floating unit 6 by a communication means (not illustrated). In the present embodiment, for example, the control part 10 may control a position and a posture of the floating unit 6 through control of the power unit that drives the articulation parts of the arm 4. A method of controlling the parts of the floating unit 6 by the control part 10 will be described later in detail.

### <Floating Unit>

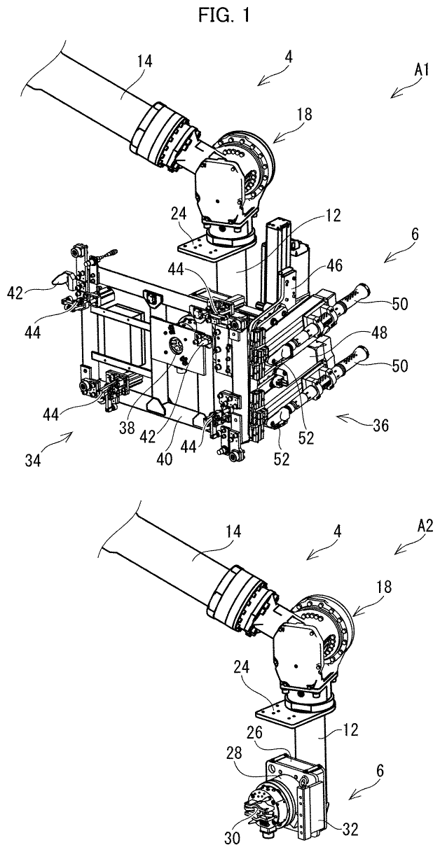

The following description will discuss the floating unit 6 in more detail with reference to FIG. 1. FIG. 1 is a diagram illustrating an enlarged region A illustrated in FIG. 2. In other words, FIG. 1 is an enlarged schematic diagram illustrating the vicinity of a tip of the arm 4 and the vicinity of the floating unit 6. Note that a schematic diagram A1 in FIG. 1 illustrates parts of the floating unit 6. Moreover, a schematic diagram A2 in FIG. 1 illustrates parts of the floating unit 6 while omitting a gripping part 34 and a nut runner unit 36 (later described in detail) in order to indicate the parts of the floating unit 6 in more detail.

As illustrated in the schematic diagram A2 in FIG. 1, the floating unit 6 includes a shock absorbing part 26, a force sensor 28, a first joint part 30, and a second joint part 32. As illustrated in the schematic diagram A1 in FIG. 1, the floating unit 6 further includes a gripping part 34 and a nut runner unit 36 which serves as a tool part.

In the present embodiment, the arm 4 is described to include the floating arm 12. Note, however, that the present embodiment is not limited to this example. For example, the floating unit 6 may include the floating arm 12 as an arm, and may further include the arm joint part 24. In other words, in the present embodiment, members that are positioned on the tip side of the arm 4 from the arm joint part 24 that is joined to the first articulation part 18 may be referred to as the floating unit 6.

The shock absorbing part 26 is an elastic member that is provided to the floating arm 12. The shock absorbing part 26 is a mechanism that absorbs stress received and reduces the stress transmitted to the floating arm 12. The shock absorbing part 26 may be, for example, an elastic member containing an elastic material such as rubber. The shock absorbing part 26 may be, for example, a cushion rubber. For example, in a case where the shock absorbing part 26 contains an elastic material such as rubber, a structure of the shock absorbing part 26 can be simplified, and also the cost can be reduced, as compared with a case where the shock absorbing part 26 has a mechanism such as a spring.

The force sensor 28 is provided to the shock absorbing part 26, and the first joint part 30 is provided to the force sensor 28. The force sensor 28 detects at least one selected from the group consisting of force or moment applied to the gripping part 34 (later described in detail). The force sensor 28 may be, for example, a six-axis force sensor. In other words, the force sensor 28 may detect at least strengths of force along respective three axial directions and strengths of moment about the three axial directions as rotation axes, which are applied to the gripping part 34.

Data of force or moment detected by the force sensor 28 may be stored in a storage part (not illustrated) such as a memory. The control part 10 may control the parts of the arm 4 and the floating unit 6 based on the data stored in the storage part, in other words, in accordance with a detection result by the force sensor 28. Specific methods for controlling the arm 4 and the floating unit 6 with use of the detection result by the force sensor 28 will be described later in detail.

The first joint part 30 is joined to the gripping part 34 (later described). Therefore, the gripping part 34 is provided to the floating arm 12 via the first joint part 30, the force sensor 28, and the shock absorbing part 26. With the configuration, the force sensor 28 can measure at least force or moment applied to the gripping part 34 as described above.

Meanwhile, the second joint part 32 is joined to the nut runner unit 36 (later described). The second joint part 32 is provided directly to the shock absorbing part 26 without the force sensor 28 disposed therebetween. Therefore, the nut runner unit 36 is provided to the floating arm 12 via the shock absorbing part 26 which is a member different from the force sensor 28. The second joint part 32 is located at a side closer to the arm 4 than the force sensor 28. In other words, the force sensor 28 is provided on the tip side of the arm 4 from the nut runner unit 36.

### <Gripping Part>

The gripping part 34 is a jig for gripping a workpiece (later described). In the present embodiment, the control part 10 controls the articulation parts of the arm 4 in a state in which the gripping part 34 grips a workpiece, and thus controls a position and a posture of the gripping part 34 and a position and a posture of the workpiece which is gripped by the gripping part 34.

The gripping part 34 includes, for example, a first joint plate 38, a support frame 40, a protrusion 42, and a gripping mechanism 44, as illustrated in the schematic diagram A1 in FIG. 1. The first joint plate 38 and the first joint part 30 are joined together by a bolt or the like, and the gripping part 34 is thus provided to the first joint part 30. The protrusion 42 and the gripping mechanism 44 are, for example, provided on the support frame 40 having a frame shape, and the support frame 40 is joined to the first joint plate 38.

The protrusion 42 is, for example, a guide for carrying out positioning of the gripping part 34 with respect to a workpiece (later described). The positioning of the gripping part 34 with respect to a workpiece using the protrusion 42 will be described later in detail.

The gripping mechanism 44 is, for example, a mechanism for gripping a workpiece, and may be, for example, a clamping mechanism including an air cylinder and a clamp that is extended and contracted by the air cylinder. Note that the embodiment is not limited to this example, and a conventionally known member that grips various workpieces may be employed as the gripping mechanism 44 in accordance with a workpiece which is to be gripped by the gripping part 34. In the present embodiment, for example, in a state in which positioning of the gripping part 34 with respect to a workpiece has been carried out with use of the protrusion 42, each gripping mechanism 44 is operated, and thus the gripping part 34 can grip a workpiece more reliably.

### <Nut Runner Unit>

The nut runner unit 36 includes, for example, a second joint plate 46, a support plate 48, and two nut runners 50. The second joint plate 46 and the second joint part 32 are joined together by a bolt or the like, and thus the nut runner unit 36 is provided to the second joint part 32. Each of the two nut runners 50 is provided, for example, on the support plate 48 provided to the second joint plate 46.

The nut runner 50 may be, for example, an electric nut runner driven by a motor (not illustrated). For example, the nut runner 50 includes, at a tip thereof, an engagement part 52 including a socket or the like which is engaged with a fastener such as a bolt. For example, in a state in which a bolt coupling two workpieces together is engaged with the engagement part 52 in the nut runner 50, the engagement part 52 may be driven to rotate by a motor so that the bolt is removed from the two workpieces. A position and a posture of each of the nut runners 50 can be changed with respect to the support plate 48. The control part 10 may control the position and the posture of each of the nut runners 50 with respect to the support plate 48 through control of the motor.

### <Example of Use of Manipulator>

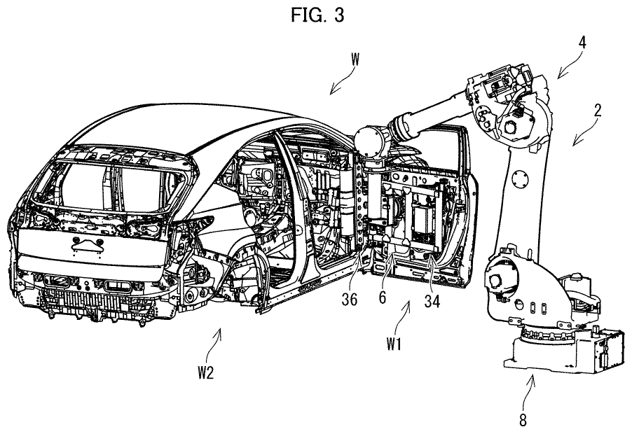

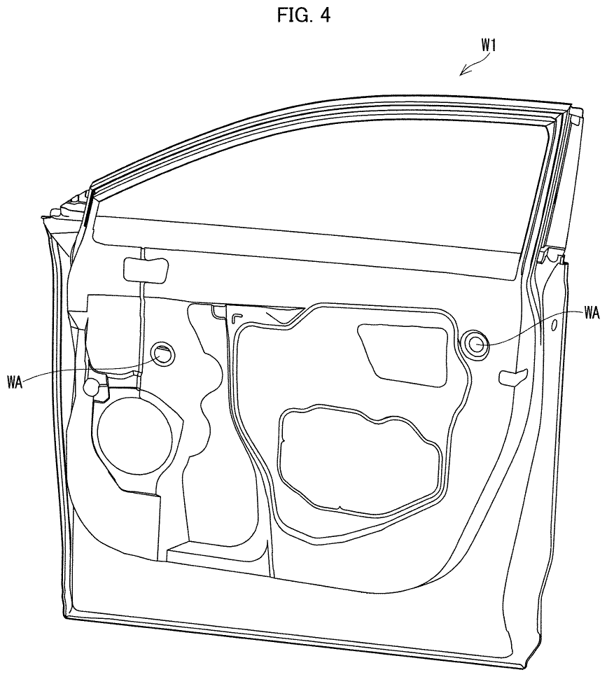

The following description will discuss a specific example of a method of using the manipulator 2, with reference to FIGS. 3 and 4. FIG. 3 is a schematic perspective view illustrating, together with the manipulator 2, a vehicle W including a door W1, which is a first workpiece that is gripped by use of the manipulator 2 in the present embodiment, and a frame W2, which is a second workpiece to which the door W1 is attached. FIG. 4 is a schematic side view illustrating the inner side of the door W1 illustrated in FIG. 3.

In the present embodiment, the manipulator 2 is, for example, a manipulator for carrying out processing with respect to the vehicle W which is transferred in a manufacturing line of the vehicle W including an automobile. In particular, in the present embodiment, the manipulator 2 is a manipulator for carrying out a process of removing the door W1, which is temporarily fixed to the frame W2 included in the vehicle W, from the frame W2. The process of removing the door W1 from the frame W2 may be carried out, for example, in order to attach components to the door W1 and the frame W2 after a coating process of coating the vehicle W in a state in which the door W1 is temporarily fixed to the frame W2.

As illustrated in FIG. 4, the door W1 has an opening WA on the inner side thereof. In the present embodiment, the opening WA is a guide on the door W1 side for carrying out positioning of the gripping part 34 with respect to the door W1 by inserting the protrusion 42 into the opening WA with a method later described.

The process of removing the door W1 from the frame W2 with use of the manipulator 2 in accordance with the present embodiment is carried out, for example, from a point in time when the vehicle W which is transferred has been transferred to a specific position (such as the vicinity of the manipulator 2). In the removal process, first, as illustrated in FIG. 3, the door W1 is gripped by the gripping part 34.

Here, in order to cause the gripping part 34 to grip the door W1, the control part 10 controls the arm 4 to carry out positioning of the gripping part 34 with respect to the door W1. The positioning of the gripping part 34 with respect to the door W1 is carried out, for example, as follows: the control part 10 controls the arm 4 in accordance with a preset program so as to move the floating unit 6 to which the gripping part 34 is provided.

Note that the floating unit 6 may further include a door opening mechanism for causing the door W1 of the transferred vehicle W to be in an opened state from a closed state. The opening of the door W1 using the door opening mechanism may be realized, for example, as follows: the control part 10 controls the arm 4 in accordance with a preset program so as to operate the door opening mechanism while moving the floating unit 6 to which the gripping part 34 is provided.

### <Protrusion and Opening>

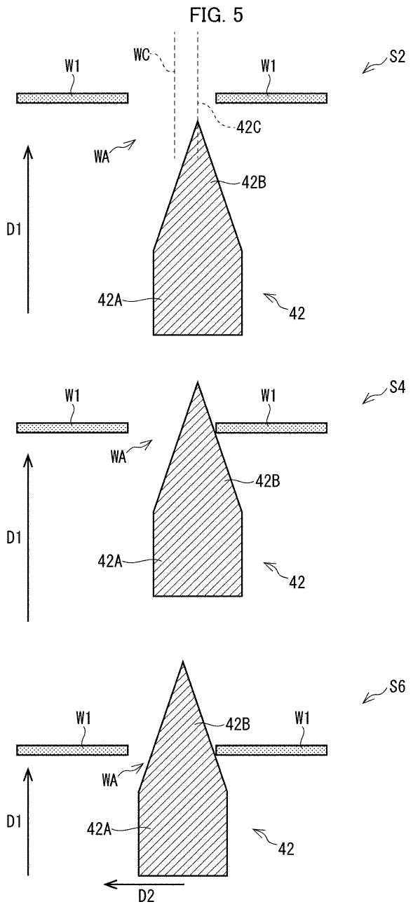

The following description will discuss a method of positioning of the gripping part 34 with respect to the door W1 in more detail, with reference to FIG. 5. FIG. 5 is a process cross-sectional view illustrating a state in which the protrusion 42 is inserted into the opening WA at the time of positioning of the gripping part 34 with respect to the door W1. FIG. 5 illustrates, for example, a cross section of the protrusion 42 and the inner wall of the door W1 in a plane passing through the protrusion 42 and the opening WA.

For example, as illustrated in the diagrams in FIG. 5, the protrusion 42 includes (i) a cylindrical part 42A which is engaged with the opening WA and (ii) a tapered part 42B which is provided to the cylindrical part 42A and has a diameter decreasing toward the tip side of the protrusion 42. For example, the tip of the tapered part 42B is at a position overlapping a center line 42C passing through the center of the cylindrical part 42A in the radial direction.

For example, in a case where the protrusion 42 is inserted into the opening WA and the cylindrical part 42A is engaged with the opening WA, the position of the gripping part 34 with respect to the door W1 is fixed. In particular, in a case where the cylindrical part 42A is engaged with the opening WA, a center line WC passing through the center of the opening WA in the radial direction overlaps the center line 42C.

Here, the opening WA is provided so that, when the protrusion 42 is inserted, the position of the gripping part 34 with respect to the door W1 is appropriate for the gripping part 34 to grip the door W1. In a case where a plurality of protrusions 42 are provided to the gripping part 34, openings WA corresponding to the respective protrusions 42 are provided on the inner side of the door W1. Therefore, by inserting the protrusion 42 into the opening WA and engaging the cylindrical part 42A with the opening WA, the gripping part 34 is positioned with respect to the door W1.

### <Profile Control>

In the process of positioning of the gripping part 34 with respect to the door W1, the floating unit 6 moves until the protrusion 42 reaches a position in the vicinity of the opening WA under control of the arm 4 by the control part 10 as illustrated in step S2 in FIG. 5. In particular, in the present embodiment, the control part 10 causes, through control of the arm 4, the floating unit 6 to move to a position where the center line 42C passes through the inside of the opening WA.

Then, the control part 10 causes, through control of the arm 4, the protrusion 42 to move in a first direction D1, which is a direction from the cylindrical part 42A of the protrusion 42 to the tip of the tapered part 42B, as illustrated in step S2 in FIG. 5. Accordingly, the protrusion 42 is inserted into the opening WA.

Here, as described above, the process of removing the door W1 from the frame W2 in accordance with the present embodiment is carried out, for example, at a point in time when the vehicle W has been transferred to a certain position. In this case, in the removal process, relative positions of the manipulator 2 and the vehicle W are ideally constant. In the removal process, a degree to which the door W1 is opened with respect to the frame W2 is set to be constant, and it is thus possible to keep the angle of the door W1 with respect to the frame W2 constant. This makes it possible to ideally keep the relative positions of the manipulator 2 and the door W1 constant in the removal process.

In this case, in the present embodiment, for example, content of control of the arm 4 by the control part 10 in positioning of the gripping part 34 with respect to the door W1 can be determined on the assumption that, when the protrusion 42 is inserted into the opening WA, the center line 42C and the center line WC overlap each other. Therefore, in a case where the control part 10 controls the arm 4 as assumed, ideally, after the center line 42C overlaps the center line WC, engagement between the opening WA and the cylindrical part 42A is achieved only by moving the protrusion 42 in the first direction D1.

However, in an actual manufacturing process of the vehicle W, positional deviation and angular deviation of the vehicle W caused when the vehicle W is moved to a conveyor or the like for transferring the vehicle W in the course of manufacturing, an error in the angle of the door W1 with respect to the frame W2, and/or the like may occur. This may cause deviation in relative positions of the manipulator 2 and the door W1. Therefore, even in a case where the control part 10 controls the arm 4 as assumed above, an error may occur in the position of the protrusion 42 with respect to the opening WA.

For example, as illustrated in step S2 in FIG. 5, the center line 42C and the center line WC may not overlap each other. Depending on the manufacturing error, directions of the center line 42C and the center line WC may not be parallel to each other. Note that a size of a diameter of the opening WA may be set such that, for example, the center line 42C always passes through the inside of the opening WA even in a case where the error occurs in the position of the protrusion 42 with respect to the opening WA.

In a case where the center line 42C and the center line WC do not overlap each other, the protrusion 42 moves in the first direction D1 and, as illustrated in step S4 in FIG. 5, the tapered part 42B of the protrusion 42 comes into contact with the inner peripheral surface of the opening WA. In this state, when the protrusion 42 is further moved in the first direction D1, force and moment generated by pressing the tapered part 42B against the inner peripheral surface of the opening WA are applied to the gripping part 34.

Here, for example, the force sensor 28 detects force and moment applied to the gripping part 34 when the tapered part 42B is pressed against the inner peripheral surface of the opening WA. Note that the force sensor 28 may detect only one of force and moment applied to the gripping part 34.

Then, the control part 10 corrects the content of control of the arm 4 based on results of detecting, by the force sensor 28, force and moment applied to the gripping part 34, and moves the protrusion 42 in a direction in which deviation of the protrusion 42 with respect to the opening WA is reduced. For example, as illustrated in step S6 in FIG. 5, through control of the arm 4 by the control part 10, the protrusion 42 is moved not only in the first direction D1 but also in a second direction D2, which is a direction in which deviation of the protrusion 42 with respect to the opening WA is reduced. For example, the control part 10 may correct the content of control of the arm 4 so as to reduce not only deviation in positions of the center line 42C and the center line WC but also deviation in directions of the center line 42C and the center line WC.

In other words, the control part 10 carries out positioning of the gripping part 34 with respect to the door W1 by carrying out profile control of the protrusion 42 with respect to the opening WA based on force and moment applied from the opening WA to the gripping part 34. This makes it possible for the control part 10 to further improve accuracy in positioning of the gripping part 34 with respect to the door W1. The control part 10 can correct the content of control of the arm 4 by profile control using the force sensor 28. Therefore, the manipulator 2 does not need to separately provide the floating unit 6 with a mechanism for controlling a position and a posture of the gripping part 34.

As such, the protrusion 42 is inserted into the opening WA and the cylindrical part 42A is engaged with the opening WA, and thus positioning of the gripping part 34 with respect to the door W1 is completed. In this state, the control part 10 controls the gripping mechanism 44 of the gripping part 34 so that the gripping part 34 grips the door W1.

Here, during the positioning of the gripping part 34 with respect to the door W1 and the gripping of the door W1 by the gripping part 34, for example, the gripping part 34 receives force and moment caused by pressing the protrusion 42 against the opening WA as described above. However, the gripping part 34 is provided to the floating arm 12 via the shock absorbing part 26, and therefore force and moment applied to the gripping part 34 are absorbed by the shock absorbing part 26. With this configuration, the shock absorbing part 26 reduces transmission, to the arm 4, of force and moment applied to the gripping part 34, and thus improves accuracy in control of the arm 4 by the control part 10. With the above configuration, even in a case where unintentional force is externally applied to the arm 4, it is possible to reduce transmission of such force to the force sensor 28 and to protect the force sensor 28.

### <Removal of Door>

Subsequent to the gripping of the door W1 by the gripping part 34, the control part 10 controls the nut runner unit 36 so as to carry out processing with respect to the door W1 by the nut runner unit 36. The processing with respect to the door W1 by the nut runner unit 36 is, for example, a process of removing a bolt, which is a joining member for joining the door W1 and the frame W2 together, from the door W1 and the frame W2 so as to remove the door W1 from the frame W2.

More specifically, the control part 10 controls positions of the respective nut runners 50 with respect to the support plate 48 so that bolts that join the door W1 to the frame W2 are engaged with the engagement parts 52 of the respective nut runners 50. In this state, the control part 10 controls rotational drive of the engagement parts 52 of the respective nut runners 50, and thus removes the bolts from the door W1 and the frame W2. As such, the door W1 is removed from the frame W2 with use of the nut runner unit 36.

Note that the gripping part 34 and the nut runner unit 36 are provided to the same floating arm 12. Therefore, a position of the nut runner unit 36 with respect to the gripping part 34 is unlikely to deviate. In addition, when the gripping part 34 grips the door W1, alignment of the gripping part 34 with respect to the door W1 is carried out. Therefore, while the gripping part 34 grips the door W1, a positional relationship of the nut runner unit 36 with respect to the door W1 can be known, and further, deviation in position of the nut runner unit 36 with respect to the door W1 can be sufficiently reduced.

Therefore, in the present embodiment, even in a case where the control part 10 has carried out control of the position of the nut runner unit 36 in accordance with a preset program, deviation in position between the nut runner unit 36 and the door W1 hardly occurs. Therefore, the control part 10 can control the nut runner unit 36 with sufficient accuracy without using the detection result by the force sensor 28.

Furthermore, the nut runner unit 36 is provided to the floating arm 12 via the shock absorbing part 26, and therefore force and moment applied to the nut runner unit 36 are absorbed by the shock absorbing part 26. With this configuration, the shock absorbing part 26 can reduce transmission, to the arm 4, force and moment applied to the nut runner unit 36. Thus, it is possible to improve accuracy in control of the arm 4 by the control part 10, and it is possible to reduce damage or the like of the arm 4.

In general, in a case where the tool part includes a member that is driven to rotate as the nut runner 50, relatively large reaction force is applied to the tool part when the tool part is used. However, the reaction force applied to the nut runner unit 36 is absorbed by the shock absorbing part 26 and hardly reaches the arm 4. In addition, the reaction force hardly reaches the force sensor 28 to which the nut runner unit 36 is not provided. Therefore, the manipulator 2 can efficiently reduce transmission, to the arm 4 and the force sensor 28, reaction force which is caused in accordance with use of the nut runner 50.

In the present embodiment, the nut runner unit 36, which is a tool part provided in the manipulator 2, is a device for removing a bolt that joins the door W1 to the frame W2 from the door W1 and the frame W2, and thus removing the door W1 from the frame W2. Note, however, that the nut runner unit 36 is not limited to this example. In the present embodiment, the tool part may be a device that releases joint between the door W1 and the frame W2. In particular, the tool part may be a device that removes at least a part of a joining member that joins the door W1 and the frame W2 together.

For example, the door W1 may be attached to the frame W2 via a pin that joins the door W1 to the frame W2. In this case, the manipulator 2 may include, as a tool part, an arm for removing the pin from the door W1 and the frame W2. Alternatively, the member for joining the door W1 to the frame W2 and a tool part provided in the manipulator 2 for releasing the joint between the door W1 and the frame W2 can be conventionally known members.

Thus, the process of removing the door W1 from the frame W2 with use of the manipulator 2 is completed. Note that, after the door W1 is removed from the frame W2 by the nut runner unit 36, the control part 10 may cause, through control of the arm 4, the position of the floating unit 6 to move in a state in which the door W1 is gripped by the gripping part 34. Thus, the control part 10 may move the door W1 which has been removed from the frame W2.

After the removal process described above, in the present embodiment, the door W1 may be reattached to the frame W2 after components are assembled to the door W1 and the frame W2. Attachment of the door W1 to the frame W2 may be carried out by a conventionally known manipulator or may be carried out, for example, by using the manipulator 2 in accordance with the present embodiment. In this case, the control part 10 may insert a bolt into the door W1 and the frame W2 through control of the arm 4, the gripping part 34, and the nut runner unit 36, and thus attach the door W1 to the frame W2.

In a case where the frame W2 is attached to the door W1 with use of the manipulator 2, the gripping part 34 may be replaced with a jig having a gripping mechanism suitable for attachment of the door W1. For example, in a case where the frame W2 is attached to the door W1, the door W1 is often provided with upholstery such as a cover on an inner side thereof. Therefore, in a case where the frame W2 is attached to the door W1 with use of the manipulator 2, the gripping part 34 may be replaced with a jig that can grip the door W1 provided with upholstery.

### <Main Points>

The manipulator 2 in accordance with the present embodiment includes the arm 4, the gripping part 34 that grips the door W1, which is a workpiece, and the nut runner unit 36 serving as a tool part that carries out processing with respect to the door W1. Here, the gripping part 34 is provided to the arm 4 via the force sensor 28, and the nut runner unit 36 is provided to the arm 4 via a member (including the shock absorbing part 26) different from the force sensor 28.

Therefore, the manipulator 2 in accordance with the present embodiment can reduce transmission, to the force sensor 28, of force and moment applied to the nut runner unit 36. Accordingly, the necessity of considering force and moment which are caused in accordance with use of the nut runner unit 36 is reduced in determining a withstand load of the manipulator 2 while taking into consideration durability of the force sensor 28 against moment. Therefore, the manipulator 2 makes it possible to detect, by the force sensor 28, at least one selected from the group consisting of force and moment applied to the gripping part 34, and to improve the withstand load of the manipulator 2.

In the manipulator 2 in accordance with the present embodiment, the nut runner unit 36 is provided to the arm 4 without the force sensor 28 disposed therebetween. Therefore, a distance between the force sensor 28 and the gripping part 34 can be made shorter because the nut runner unit 36 is not provided to the force sensor 28, and furthermore a distance between the force sensor 28 and a workpiece which the gripping part 34 grips can be made shorter. Thus, the manipulator 2 can also reduce transmission, to the force sensor 28, of force and moment generated when the arm 4 is operated in a state in which the gripping part 34 grips a workpiece.

In the present embodiment, the force sensor 28 is provided on the tip side of the arm 4 from the nut runner unit 36. Therefore, the manipulator 2 can more efficiently reduce transmission, to the force sensor 28, of force and moment applied to the nut runner unit 36, and further improve the withstand load of the manipulator 2.

The manipulator 2 includes the control part 10 that carries out position control of the gripping part 34 and control of processing with respect to the door W1 by the nut runner unit 36. In particular, the control part 10 carries out position control of the gripping part 34 in accordance with a result of detecting, by the force sensor 28, force and moment applied to the gripping part 34. Therefore, the manipulator 2 can carry out positioning of the gripping part 34 with respect to the door W1 with higher accuracy.

For example, positioning of the gripping part 34 with respect to the door W1 is carried out by profile control of the protrusion 42 of the gripping part 34 with respect to the opening WA of the door W1 by the control part 10. In this case, even in a case where deviation occurs in the position of the door W1 with respect to the manipulator 2, the control part 10 can accurately carry out the positioning of the gripping part 34 with respect to the door W1.

In the present embodiment, the force sensor 28 may be a six-axis force sensor. In general, a six-axis force sensor can detect force and moment more precisely than a uniaxial force sensor or the like that detects only force in a certain one direction. Meanwhile, in many cases, durability of the six-axis force sensor against moment is lower than that of the uniaxial force sensor because a mechanism of the six-axis force sensor is complicated. Therefore, in a case where the force sensor 28 is a six-axis force sensor, the effect in which the manipulator 2 in accordance with the present embodiment reduces transmission of force and moment from the nut runner unit 36 to the force sensor 28 is more remarkably brought about. Furthermore, in a case where the force sensor 28 is a six-axis force sensor, the effect of reducing transmission, to the force sensor 28, of force and moment generated when the arm 4 is operated in a state in which the gripping part 34 grips a workpiece is also more remarkably brought about.

In the present embodiment, the manipulator 2 includes, as a tool part, the nut runner unit 36 including the nut runner 50 for removing the door W1 gripped by the gripping part 34 from the frame W2. In particular, the nut runner 50 rotates a bolt joining the door W1 to the frame W2 by rotational drive of the engagement part 52 in a state in which the bolt is engaged with the engagement part 52, and thus removes the bolt from the door W1 and the frame W2.

As such, in general, a device for releasing joint of two members needs to apply relatively strong force or moment to each of the members in order to release the joint. In particular, a device that removes at least a part of a joining member that joins two members together often needs to remove the joining member from the two members by applying force to the joining member in addition to gripping of the joining member. Therefore, in a case where the above-described device is employed as the tool part provided in the manipulator 2 in accordance with the present embodiment, it is possible to more efficiently reduce transmission, to the arm 4 and the force sensor 28, of reaction force caused in accordance with use of the tool part.

In the present embodiment, for example, the manipulator 2 may include, in addition to the nut runner unit 36, various conventionally-known processing devices as tool parts that carry out processing with respect to the door W1 gripped by the gripping part 34. In this case also, the tool part is provided to the arm 4 without the force sensor 28 disposed therebetween. Therefore, the manipulator 2 reduces transmission, to the force sensor 28, of reaction force applied to the tool part.

In the present embodiment, an example has been described in which the manipulator 2 is used in a manufacturing line of a vehicle W. Note, however, that the present embodiment is not limited to this example. For example, the manipulator 2 may be used as various conventionally known manipulators a for processing workpiece while gripping the workpiece which is transferred.

In general, however, in a case where the manipulator is used to remove a door of a vehicle from a frame, a certain degree of accuracy is demanded in positioning of a gripping part of the manipulator with respect to the door. Furthermore, due to a heavy weight of the door, the manipulator for removing the door from the frame needs to have a certain degree of withstand load.

The manipulator 2 in accordance with the present embodiment can carry out positioning of the gripping part 34 with respect to a workpiece with higher accuracy and improve a withstand load of the manipulator 2. Therefore, by employing the manipulator 2 in accordance with the present embodiment as a manipulator in a manufacturing line of a vehicle W, a yield of the vehicle W is efficiently improved, and damage or wear of the manipulator 2 is efficiently reduced.

The present disclosure is not limited to the embodiments, but can be altered variously by a skilled person in the art within the scope of the claims. The present disclosure also encompasses, in its technical scope, any embodiment derived by appropriately combining the different technical means disclosed in respective embodiments.

### REFERENCE SIGNS LIST

2: Manipulator
4: Arm
10: Control part
26: Shock absorbing part
28: Force sensor
34: Gripping part
36: Nut runner unit (tool part)
42: Protrusion
50: Nut runner
W: Vehicle
W1: Door
W2: Frame
WA: Opening

1. A manipulator, comprising:
an arm;
a force sensor that is provided to the arm;
a gripping part that is provided to the arm via the force sensor and grips a first workpiece; and
a tool part that is provided to the arm via a member different from the force sensor and carries out processing with respect to the first workpiece which is gripped by the gripping part.

2. The manipulator as set forth in claim 1, further comprising:
a control part that carries out position control of the gripping part in accordance with a detection result by the force sensor.

3. The manipulator as set forth in claim 2, wherein:
the gripping part includes a protrusion;
the first workpiece includes an opening; and
the control part carries out positioning of the gripping part with respect to the first workpiece by causing the protrusion to engage with the opening by profile control of the protrusion with respect to the opening.

4. The manipulator as set forth in claim 1, wherein:
the force sensor is a six-axis force sensor.

5. The manipulator as set forth in claim 1, wherein:
the force sensor is provided on a tip side of the arm from the tool part.

6. The manipulator as set forth in claim 1, further comprising:
a shock absorbing part,
at least one selected from the group consisting of the force sensor and the tool part being provided to the arm via the shock absorbing part.

7. The manipulator as set forth in claim 6, wherein:
the shock absorbing part is an elastic member containing an elastic material.

8. The manipulator as set forth in claim 1, wherein:
the tool part is a device that releases a joint between the first workpiece and a second workpiece which is different from the first workpiece.

9. The manipulator as set forth in claim 8, wherein:
the tool part is a device that removes at least a part of a joining member that joins the first workpiece to the second workpiece.

10. The manipulator as set forth in claim 8, wherein:
the tool part includes a nut runner.

11. The manipulator as set forth in claim 8, wherein:
the first workpiece is a door of a vehicle, and the second workpiece is a frame of the vehicle.
